(19) United States
(12) Patent Application Publication
(10) Pub. No.: US 2015/0348003 A1
(43) Pub. Date: Dec. 3, 2015

(54) Method and System for Facilitating Customer Reactions to Proximity Mobile Payment Transactions

(71) Applicant: Scot Anthony Reader, Boulder, CO (US)

(72) Inventor: Scot Anthony Reader, Boulder, CO (US)

(21) Appl. No.: 14/289,488

(22) Filed: May 28, 2014

(51) Int. Cl. G06Q 20/32

(52) U.S. Cl. CPC G06Q 20/3224; G06Q 20/3278

(57) ABSTRACT

A method and system for facilitating customer reactions to service received in proximity mobile payment transactions, such as near field communication payment transactions. In the method and system, when a customer smartphone is brought into proximity with a merchant point of sale terminal to conduct a proximity mobile payment transaction, an identifier of the merchant, an identifier of a service worker representing the merchant, or both, are downloaded from the terminal to the smartphone and stored in a transaction record. When the customer wishes to react to the service received in the transaction, the customer interacts with the system to select the transaction record and formulate a customer reaction addressing the merchant, service worker, or both, by invoking customer reaction widgets. The customer reaction is delivered to recipients designated by the customer. The customer reaction may be a rating, recommendation, correspondence, reservation request, deferred tip or preset tip.

### BACKGROUND OF THE INVENTION

The present invention relates to proximity mobile payment transactions and, more particularly, facilitating customer reactions to proximity mobile payment transactions.

Proximity mobile payment transactions are commercial transactions in which a customer uses a mobile device to pay for goods or services at a physical point of sale (POS) by bringing the mobile device into proximity with a merchant POS terminal. One type of proximity mobile payment transaction is a near field communication (NFC) payment transaction. To perform an NFC payment transaction, a customer's NFC-capable smartphone is provisioned with a payment application and customer payment information (e.g., credit, debit or prepaid account information). When the customer brings the smartphone into proximity with an NFC-capable merchant POS terminal, the customer payment information is sent to the merchant POS terminal via the NFC protocol. The merchant POS terminal uses the customer payment information to complete payment for the goods or services in a process similar to that used when a customer pays for goods or services with a magnetic stripe credit or debit card.

While proximity mobile payment transactions have substantial advantages over cash and magnetic “card swipe” transactions in terms of reliability, security and ease of use, one area largely neglected to date is how to leverage proximity mobile payment technology to facilitate customer reactions to service received in such transactions. Traditionally, tipping of service workers has been the main way to express customer satisfaction or dissatisfaction with service received in commercial transactions. Yet tipping is an imperfect vehicle for such expressions, especially in proximity mobile payment transactions. Tipping conveys limited information about customer satisfaction with the service and often has no reverberations outside the transaction in which the tip is given. While service workers are aware of the good or bad tips they receive, the merchant for whom they work and the public at large is often not made aware. Moreover, a good or bad tip does not explain the reason for a customer's satisfaction or dissatisfaction so that good service can be replicated or bad service remediated. Additionally, in proximity mobile payment transactions, service workers may not be aware of the tips they received in specific transactions since they are often not intimately involved in bill presentation or payment collection. Indeed, some proximity mobile payment systems do not provide a way to tip within the transaction flow.

Other means for expressing customer satisfaction or dissatisfaction with service received in commercial transactions, such as online reviews, ratings and recommendations and direct correspondence with merchants and service workers, can be more impactful than tipping. Yet customers have tended to underutilize these means of expression due to the time and effort involved, not knowing or remembering a service worker's name, not having ready contact information for a service worker or merchant, or simply forgetting. Moreover, these means of expression typically leave to the discretion of others whether the good or poor service has an economic consequence for the service worker or merchant.

Finally, aside from expressing customer satisfaction or dissatisfaction with service received in a transaction, a customer may wish to cultivate a social relationship with a service worker who represented a merchant in a transaction, but may be inhibited from doing so because the customer does not have the service worker's contact information or know his or her marital or dating status.

### SUMMARY OF THE INVENTION

The present invention provides a method and system for facilitating customer reactions to service received in proximity mobile payment transactions, such as NFC payment transactions. In the method and system, when a smartphone operated by a customer is brought into proximity with a POS terminal operated by a merchant to conduct a proximity mobile payment transaction, an identifier of the merchant, an identifier of a service worker representing the merchant in the transaction, or both, are downloaded from the POS terminal to the smartphone and stored in a transaction record. When the customer wishes to react to the service received in the transaction, the customer interacts with the smartphone or another computer to select the transaction record and formulate a customer reaction addressing the merchant, the service worker, or both, by invoking customer reaction widgets. The customer reaction may be a rating, recommendation, correspondence, reservation request, deferred tip or preset tip, and is delivered to recipients designated by the customer.

In one aspect of the invention, a method for facilitating a customer reaction to a proximity mobile payment transaction comprises receiving on a smartphone from a POS terminal, while the smartphone and the POS terminal are in proximity for a proximity mobile payment transaction, an identifier of a merchant and an identifier of a service worker representing the merchant; storing a record of the transaction including the merchant identifier and the service worker identifier; receiving a selection of the transaction record on a user interface; receiving one or more customer reaction inputs made by invoking one or more customer reaction widgets on the user interface; and delivering to one or more recipients a customer reaction addressing at least one of the merchant or the service worker generated using the transaction record and the customer reaction inputs.

In some embodiments, the customer reaction widgets comprise a rating widget.

In some embodiments, the customer reaction widgets comprise a recommendation widget.

In some embodiments, the customer reaction widgets comprise a correspondence widget.

In some embodiments, the customer reaction widgets comprise a reservation request widget.

In some embodiments, the customer reaction widgets comprise a deferred tipping widget.

In some embodiments, the customer reaction widgets comprise a preset tipping widget.

In some embodiments, the customer reaction widgets comprise a recipient designation widget.

In some embodiments, the customer reaction widgets comprise a privacy designation widget.

In some embodiments, the customer reaction widgets comprise a response request widget.

In some embodiments, the user interface is on the smartphone.

In some embodiments, the user interface is on one of a desktop, notebook or tablet computer.

In some embodiments, the customer reaction is generated through interaction of the smartphone with a cloud service.

In some embodiments, the customer reaction is delivered to the recipients by a cloud service.

In some embodiments, the customer reaction is generated on the smartphone without interaction with a cloud service.

In some embodiments, the customer reaction is delivered to the recipients by the smartphone.

In some embodiments, the customer reaction is delivered to the recipients while the smartphone and the POS terminal are in proximity for a subsequent proximity mobile payment transaction.

In some embodiments, the customer reaction is a deferred tip delivered to an online payment account of the service worker.

In some embodiments, the customer reaction is a preset tip delivered to the service worker while the smartphone and the POS terminal are in proximity for a subsequent proximity mobile payment transaction.

In some embodiments, the proximity mobile payment transaction is a NFC payment transaction.

In another aspect of the invention, a smartphone comprises a proximity mobile communication interface configured to receive from a POS terminal, while the smartphone and the POS terminal are in proximity for a proximity mobile payment transaction, an identifier of a merchant and an identifier of a service worker representing the merchant, and further configured to deliver to a POS terminal a customer reaction addressing at least one of the merchant or the service worker; a memory configured to store a record of the transaction including the merchant identifier and the service worker identifier; a user interface configured to receive a selection of the transaction record and further configured to receive one or more customer reaction inputs made by invoking one or more customer reaction widgets; and a processor configured to generate the customer reaction using the transaction record and the customer reaction inputs.

In some embodiments, the customer reaction is a tip for the service worker.

In some embodiments, the customer reaction is a preset tip for the service worker delivered while the smartphone and the POS terminal are in proximity for a subsequent proximity mobile payment transaction.

In some embodiments, the proximity mobile communication interface is a NFC interface.

In another aspect of the invention, a method for facilitating a customer reaction to a proximity mobile payment transaction comprises receiving on a smartphone from a POS terminal, while the smartphone and the POS terminal are in proximity for a proximity mobile payment transaction, an identifier of a service worker representing a merchant; storing a record of the transaction including the service worker identifier; receiving a selection of the transaction record on a user interface; accessing a web address of a profile of the service worker using the service worker identifier; receiving a request to review the profile made by invoking a service worker profile widget on the user interface; accessing the profile using the web address; and displaying the profile on the user interface.

In some embodiments, the profile is hosted on a third party social networking platform.

In some embodiments, the proximity mobile payment transaction is a NFC payment transaction.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a NFC payment transaction conducted using a customer smartphone and a merchant POS terminal.

FIG. 2 shows a customer smartphone used in a cloud-based embodiment for facilitating customer reactions to NFC payment transactions conducted using the customer smartphone.

FIG. 3 shows a network infrastructure used in a cloud-based embodiment for facilitating customer reactions to NFC payment transactions conducted using the customer smartphone.

FIG. 4 is a transaction summary page summarizing recent NFC payment transactions conducted using the customer smartphone and containing hyperlinks to transaction details.

FIG. 5 is a transaction details page providing details for a recent NFC payment transaction conducted using the customer smartphone and containing a hyperlink to a service worker profile and an action button linking to a customer reaction home page.

FIG. 6 is a customer reaction home page containing action buttons linking to different reaction type pages containing widgets for configuring different types of customer reactions to a NFC payment transaction.

FIG. 7 is a rating page containing rating widgets allowing the customer to rate a service worker or merchant.

FIG. 8 is a recommendation page containing recommendation widgets allowing the customer to indicate whether a service worker or merchant is recommended.

FIG. 9 is a correspondence page containing correspondence widgets allowing the customer to create and deliver correspondence to a service worker or merchant.

FIG. 10 is a reservation page containing reservation widgets allowing the customer to request a reservation with a service worker or merchant.

FIG. 11 is a deferred tipping page containing deferred tipping widgets allowing the customer to give a belated tip to a service worker.

FIG. 12 is a preset tipping page containing preset tipping widgets allowing the customer to preset a tip to be automatically paid to a service worker or merchant in subsequent NFC payment transactions.

FIG. 13 shows a cloud-based method for facilitating a customer reaction a NFC payment transaction conducted using the customer smartphone and a merchant POS terminal.

FIG. 14 shows a customer smartphone used in a client-based embodiment for facilitating customer reactions to NFC payment transactions conducted using the customer smartphone.

FIG. 15 shows a client-based method for facilitating a customer reaction a NFC payment transaction conducted using the customer smartphone and a merchant POS terminal.

### DETAILED DESCRIPTION OF A PREFERRED EMBODIMENT

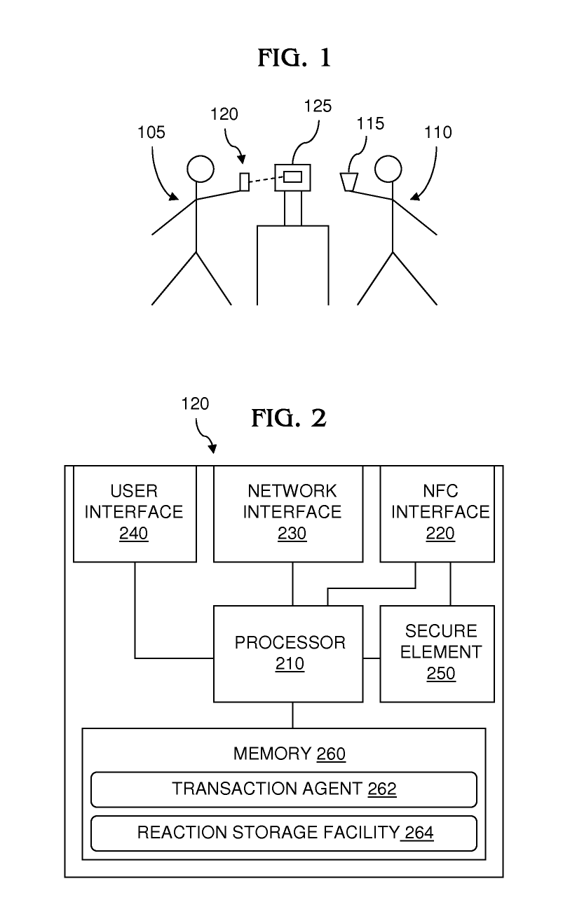

FIG. 1 shows a NFC payment transaction conducted using a smartphone 120 operated by a customer 105 and a POS terminal 125 operated by a merchant. In the NFC payment transaction, customer 105 purchases a good 115 (e.g., a beverage) from the merchant who is represented in the transaction by a service worker 110. Customer 105 pays for good 115 by bringing smartphone 120 into proximity with POS terminal 125. When smartphone 120 is proximate POS terminal 125, customer payment information, such as a credit, debit or prepaid account number, is uploaded to POS terminal 125 via NFC data transfer. POS terminal 125 uses the customer payment information to complete payment for good 115 (e.g., by consulting a financial accounting infrastructure that validates the customer payment information and transfers funds from a customer account to a merchant account). Moreover, in the present method and system, while smartphone 120 is proximate POS terminal 125, transaction data including an identifier of the merchant and an identifier of service worker 110 are downloaded from POS terminal 125 to smartphone 120 via NFC data transfer. These transaction data are used to facilitate a customer reaction to the service received in the NFC payment transaction.

While POS terminal 125 is shown in FIG. 1 to be stationary, a mobile POS terminal (e.g., a handset carried by the service worker) may be used. In that case, smartphone 120 may be brought into proximity with the POS terminal by moving the mobile POS terminal toward smartphone 120, or moving smartphone 120 and the mobile POS terminal toward one another.

FIGS. 2-13 illustrate a cloud-based embodiment of the present method and system for facilitating customer reactions to NFC payment transactions. In the cloud-based embodiment, smartphone 120 uploads the transaction data downloaded from POS terminal 125 to a cloud service 310, which creates a transaction record including the transaction data and stores the transaction record in association with a user account of customer 105. The transaction record includes the merchant and service worker identifiers as well as the date and time of the transaction. The date and time may be part of the transaction data downloaded to smartphone 120 from POS terminal 125 via NFC data transfer. Alternatively, smartphone 120 may add a timestamp to the transaction data downloaded from POS terminal 125 indicating the date and time of the transaction before uploading the transaction data to cloud service 310. The transaction record created by cloud service 310 and stored may include other information, such as the amount of the transaction or a description of good 115.

FIG. 2 describes transaction record creation and storage in the cloud-based embodiment in more detail. When customer 105 wishes to purchase good 115 using smartphone 120, customer 105 provides an indication on user interface 240 to make a NFC payment. In response, processor 210 invokes a NFC payment application installed on a secure element 250 and a transaction agent 262 installed in memory 260, both of which execute. Customer 105 then brings smartphone 120 into proximity with POS terminal 125 (e.g., within about four inches or less). While smartphone 120 and POS terminal 125 are in proximity, transaction agent 262 collects data related to the NFC payment transaction downloaded from POS terminal 125 over an NFC interface 220 via the NFC protocol and the NFC payment application causes customer payment information to be uploaded from secure element 250 to POS terminal 125 over NFC interface 220 via the NFC protocol. The transaction data collected by transaction agent 262 include an identifier of the merchant and an identifier of service worker 110 and may also include the date and time of the transaction and other information. If the date and time of the transaction are not part of the downloaded transaction data, transaction agent 262 may add to the transaction data a timestamp with the date and time of the transaction. Transaction agent 262 associates the transaction data with a user account of customer 105 maintained in user account database 350 and uploads the transaction data via a network interface 230 to a cloud server 312, which is a cloud computing device operating in a cloud service 310. Cloud server 312 creates a transaction record using the uploaded transaction data and stores the transaction record in a transaction database 360 in association with the user account of customer 105. Network interface 230 may be a cellular interface or a wireless data interface, such as an Wi-Fi interface.

Transaction agent 262 may receive the transaction data downloaded from POS terminal 125 directly from POS terminal 125. Alternatively, the transaction data may first be downloaded to secure element 250 and then transaction agent 262 may obtain the transaction data from secure element 250. Moreover, while the cloud-based embodiment is described in relation to customer 105 and smartphone 120, cloud service 310 supports other customers who have user accounts established in user account database 350 and who engage in NFC payment transactions with merchants using smartphones.

After completing one or more NFC payment transactions in which transaction records linked with the user account of customer 105 are created and stored in transaction database 360, customer 105 logs-in to the user account from a user interface on smartphone 120 or a computer 320 belonging to customer 105 and interacts with cloud service 310 to formulate a customer reaction to service received in one or more of the transactions. Computer 320 may be, for example, a desktop, notebook or tablet computer. Customer 105 configures a customer reaction to service received in a NFC payment transaction by locating the record for the transaction of interest through user input, selecting the transaction record through user input, and invoking customer reaction widgets through user input to produce customer reaction inputs. User input may include touch screen input, keyboard input, computer mouse input or other types of input, depending on the user interface capabilities of smartphone 120 or computer 320. Once configured, cloud server 312 places the customer reaction into a deliverable format using the transaction record and the customer reaction inputs.

Customer 105 may log-in to the user account and configure the customer reaction from a conventional web browser executing on smartphone 120 or computer 320 that interacts with cloud server 312. Alternatively, smartphone 120 or computer 320 may have a custom software application executing thereon through which customer 105 logs-in to the user account and configures the customer reaction through interaction with cloud server 312.

When customer 105 uses smartphone 120 to log-in and configure a customer reaction, interactions with customer 105 are conducted under the control of processor 210 via user interface 240 and interactions with cloud service 310 are conducted under the control of processor 210 via network interface 230.

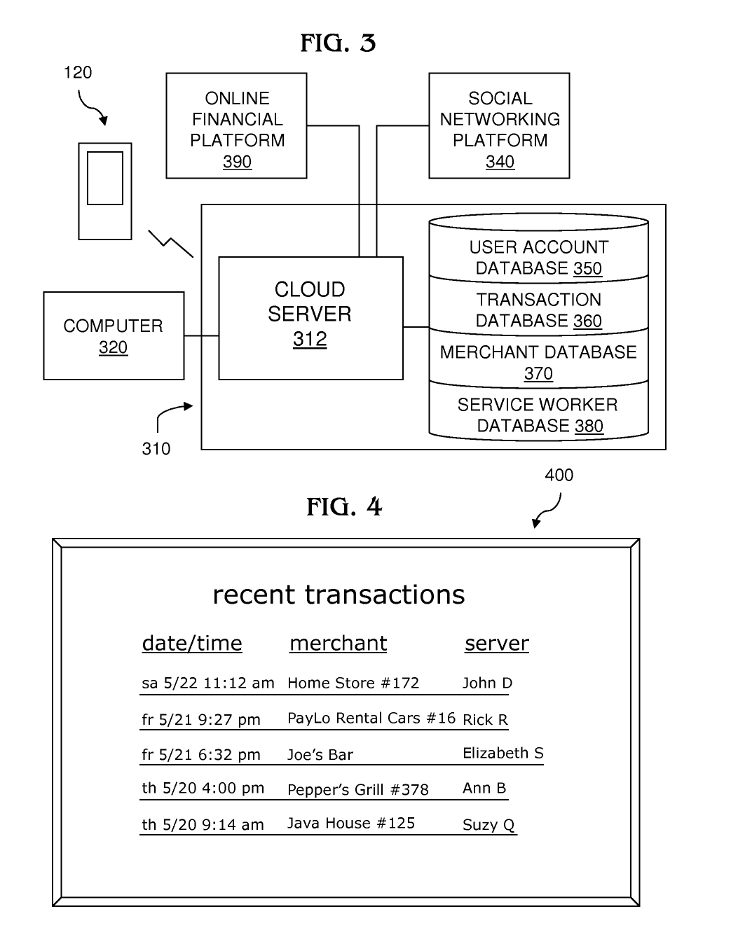

Referring to FIG. 4, once customer 105 has logged-in to the user account, a transaction summary page 400 is generated by cloud server 312 and displayed on smartphone 120 or computer 320. Transaction summary page 400 summarizes recent NFC payment transactions completed using smartphone 120. The transaction summaries include summary data from transaction records stored in transaction database 360 in association with the user account. The summary data for each transaction include a date and time of the transaction as well as the identities of the merchant and of the service worker who represented the merchant in the transaction. For merchants who do business from more than one location, the merchant identifier includes an identifier (e.g., a store number) that uniquely identifies the location where the transaction occurred. The service worker identifier includes the full first name and the first letter of the last name of the service worker. Naturally, other conventions may be used to identify merchants and/or service workers. Each transaction summary includes a hyperlink that may be activated by customer 105 through user input to select the transaction record of interest (hereinafter “the selected transaction”).

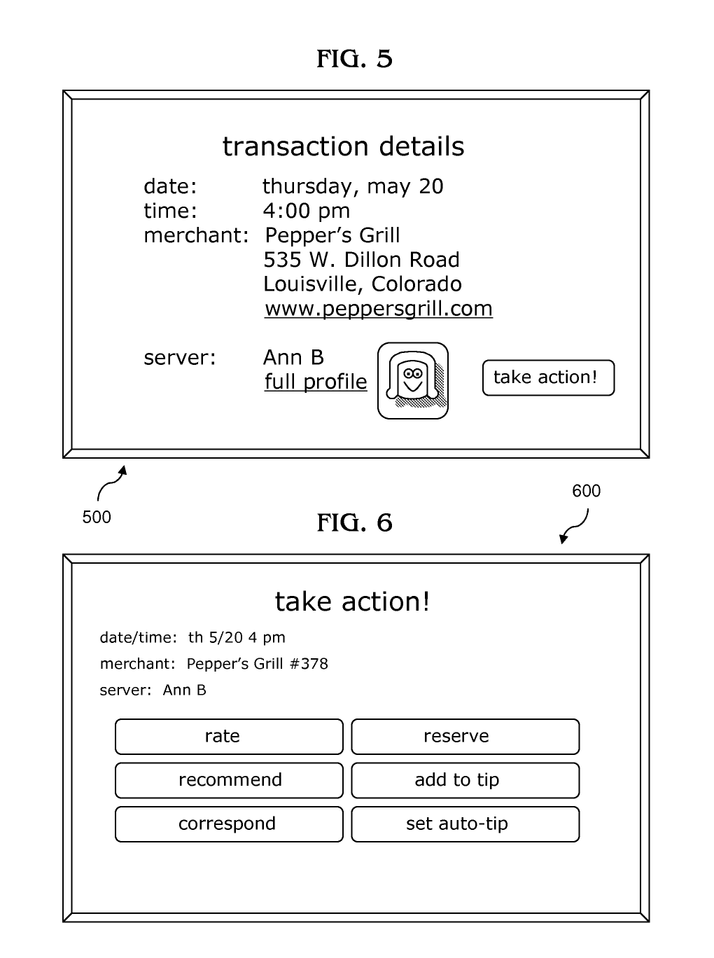

When customer 105 activates a hyperlink for one of the transaction summaries, a transaction details page is generated for the selected transaction and displayed on smartphone 120 or computer 320. Referring to FIG. 5, transaction details page 500 identifies the date and time of the selected transaction as well as a physical address of the merchant location where the selected transaction occurred and a link to the merchant's website. The merchant details are retrieved by cloud server 312 from a merchant database 370 using the merchant identifier from the selected transaction as a lookup key. Transaction details page 500 also includes a thumbnail image of the service worker who represented the merchant in the selected transaction and a hyperlink to a profile of the service worker. The thumbnail image and the profile hyperlink are retrieved by cloud server 312 from a service worker database 380 using the merchant and service worker identifiers from the selected transaction as a lookup key. The profile hyperlink may be a web address of a public profile of the service worker hosted on a third party social networking platform 340, such as Facebook or Linkedin. Transaction details page 500 further includes a “take action!” action button linking to a customer reaction home page.

Merchant database 370 and service worker database 380 may be pre-populated with information about the merchant and the service worker, respectively. This information may be supplied by the merchant, the service worker, users of the system, system administrators, or more than one of these sources.

Referring to FIG. 6, when customer 105 activates the “take action!” action button on transaction details page 500, customer reaction home page 600 is generated for the selected transaction and displayed on smartphone 120 or computer 320. Customer reaction home page 600 includes a summary of the selected transaction and action buttons linking to different customer reaction type pages containing customer reaction widgets for configuring different types of customer reactions to the selected transaction. A “rate” action button links to a rating page containing widgets allowing customer 105 to rate the service worker or merchant involved in the selected transaction. A “recommend” action button links to a recommendation page containing widgets allowing customer 105 to indicate whether the service worker or merchant is recommended. A “correspond” action button links to a correspondence page containing widgets allowing customer 105 to create and direct correspondence to the service worker or merchant. A “reserve” action button links to a reservation page containing widgets allowing customer 105 to request a reservation with the service worker or merchant. An “add to tip” action button links to a deferred tipping page containing widgets allowing customer 105 to give a belated gratuity to the service worker. A “set auto-tip” action button links to a preset tipping page containing widgets allowing customer 105 to preset a gratuity to be automatically paid to the service worker or merchant in subsequent NFC payment transactions.

Customer reaction widgets may include various kinds of graphical user interface elements that are invocable by customer 105 through user input to provide predetermined kinds of customer reaction inputs. Customer reaction widgets may include, without limitation, action buttons, calendar widgets, checkboxes, drop-down lists, hyperlinks, radio buttons, slider widgets and text boxes.

### Rating

When customer 105 activates the “rate” action button on home page 600, a rating page is generated for the selected transaction and displayed on smartphone 120 or computer 320. Referring to FIG. 7, rating page 700 identifies the service worker and merchant involved in the selected transaction and contains widgets allowing customer 105 to rate the service worker or merchant.

Rating page 700 includes a drop-down list allowing customer 105 to select whether the rating applies to the service worker or the merchant. If the merchant is selected, the merchant is identified as the subject of the rating to recipients of the rating. If the service worker is selected, the service worker is identified as the subject of the rating to recipients of the rating.

Rating page 700 further includes a slider widget allowing customer 105 to score the service worker or the merchant on a number scale from zero to ten, with ten being best. The score selected by customer 105 using the slider widget is the rating criterion delivered to recipients. A rating page may have a drop-down list instead of a slider widget for inputting the score.

Rating page 700 further includes checkboxes allowing customer 105 to designate recipients of the rating by checking applicable boxes. Customer 105 fills the checkboxes to designate the community, the service worker (i.e., “server”) and/or the merchant as recipients.

If customer 105 designates the community as a recipient, the rating is published to a community ratings page accessible to users of the system via cloud service 310.

If customer 105 designates the service worker as a recipient, the rating is delivered to the service worker. In this regard, cloud server 312 may send a message containing the rating to an email or text message account of the service worker. Cloud server 312 may obtain the account address from service worker database 380 using the merchant identifier and service worker identifier from the selected transaction as a lookup key. Alternatively, cloud server 312 may post a social networking message containing the rating to the service worker's profile on social networking platform 340. Cloud server 312 may obtain the web address of the profile from service worker database 380 using the merchant identifier and service worker identifier from the selected transaction as a lookup key. In a further alternative, cloud server 312 may download the rating to a reaction storage facility 264 on smartphone 120. In this case, transaction agent 262 may automatically upload a message containing the rating to a service worker account on a message server at the merchant's premises in response to receiving the merchant identifier and the service worker identifier from a POS terminal in a subsequent NFC payment transaction with the merchant. Such a message may be uploaded to the message server via a short-range communication protocol, such as NFC, Bluetooth or Wi-Fi.

If customer 105 designates the merchant as a recipient, the rating is delivered to the merchant. In this regard, cloud server 312 may send a message containing the rating to an email or text message account of the merchant. Cloud server 312 may obtain the account address of the merchant from merchant database 370 using the merchant identifier from the selected transaction as a lookup key. Alternatively, cloud server 312 may post a message containing the rating to the merchant's website. The merchant's web address may be obtained from merchant database 370 using the merchant identifier from the selected transaction as a lookup key. In yet another alternative, the rating may be downloaded by cloud server 312 to reaction storage facility 264 on smartphone 120 and transaction agent 262 may automatically upload a message containing the rating to a merchant account on a message server at the merchant's premises in response to receiving the merchant identifier from a POS terminal in a subsequent NFC payment transaction with the merchant. In this alternative, the message may be uploaded to the message server via a short-range communication protocol, such as NFC, Bluetooth or Wi-Fi.

More than one recipient may be designated. For example, if customer 105 selects “community” and “server” as recipients, a message containing the rating may be published to a community ratings page accessible to all users of the system and sent to an email account of the service worker.

Rating page 700 further includes radio buttons allowing customer 105 to maintain anonymity, if desired, by not having his or her identity linked to the customer reaction. If customer 105 selects “yes,” a customer identifier obtained from the user account of customer 105 is delivered with the rating. If customer 105 selects “no,” the rating is delivered without the customer identifier.

Rating page 700 further includes a community ratings hyperlink. When customer 105 activates the community ratings hyperlink, a rating page is generated containing ratings of the service worker or the merchant published by users of the system and displayed on smartphone 120 or computer 320.

Finally, rating page 700 includes an “apply rating” action button. Activation of the “apply rating” action button indicates that configuration of the customer rating is complete, at which point cloud server 312 places the rating into deliverable format using the transaction record and the customer inputs.

### Recommendation

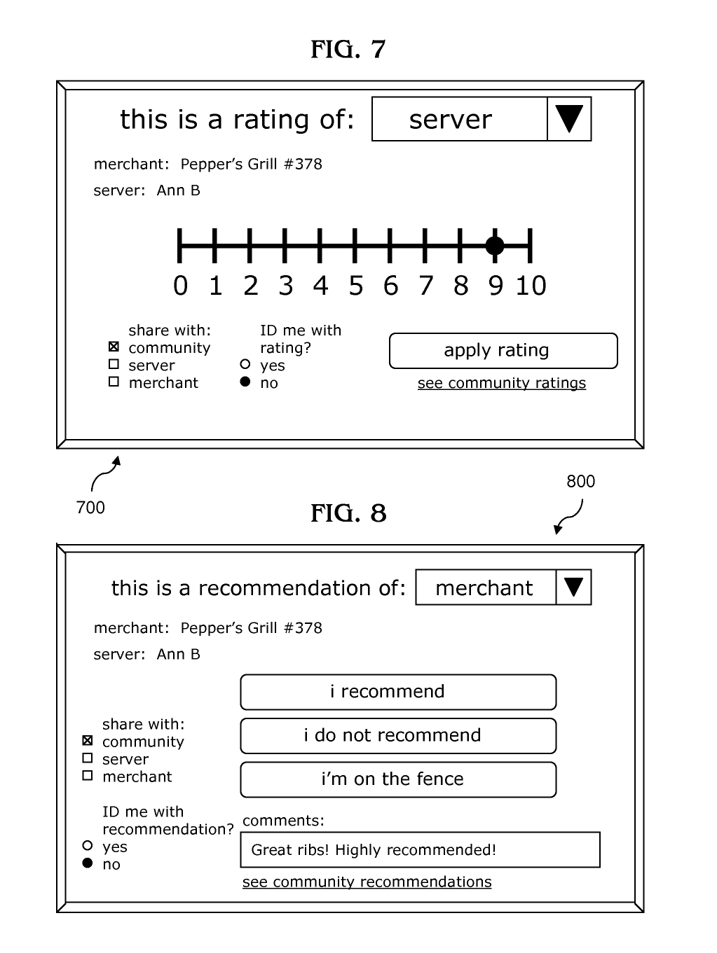

When customer 105 activates the “recommend” action button on home page 600, a recommendation page is generated for the selected transaction and displayed on smartphone 120 or computer 320. Referring to FIG. 8, recommendation page 800 identifies the service worker and merchant involved in the selected transaction and contains widgets allowing customer 105 to indicate whether or not the service worker or merchant is recommended.

Recommendation page 800 includes a drop-down list allowing customer 105 to select whether the recommendation applies to the service worker or the merchant. If the merchant is selected, the merchant is identified as the subject of the recommendation to recipients. If the service worker is selected, the service worker is identified as the subject of the recommendation to recipients.

Recommendation page 800 further includes checkboxes allowing customer 105 to designate recipients of the recommendation by checking applicable boxes. These checkboxes function, and the recommendation is delivered to recipients, as described above in relation to rating checkboxes and rating message delivery.

Recommendation page 800 further includes radio buttons allowing customer 105 to indicate whether or not he or she wishes to be identified as the source of the customer reaction. If customer 105 selects “yes,” a customer identifier associated with a user account of customer 105 is delivered with the recommendation. If customer 105 selects “no,” the recommendation is delivered without adding the customer identifier.

Recommendation page 800 further includes a text box allowing customer 105 to provide a comment with the recommendation. If customer 105 writes a comment in the text box, the comment is delivered with the recommendation.

Recommendation page 800 further includes a community recommendations hyperlink. When customer 105 activates the community recommendations hyperlink, a recommendations page is generated containing recommendations of the service worker or merchant published by users of the system and displayed on smartphone 120 or computer 320.

Finally, recommendation page 800 includes action buttons allowing customer 105 to indicate whether or not the service worker or merchant is recommended. The statement of recommendation shown on the action button activated by customer 105 is the one delivered to recipients. Activation of one of the action buttons indicates that configuration of the customer recommendation is complete whereupon cloud server 312 places the recommendation into deliverable format using the transaction record and the customer inputs.

### Correspondence

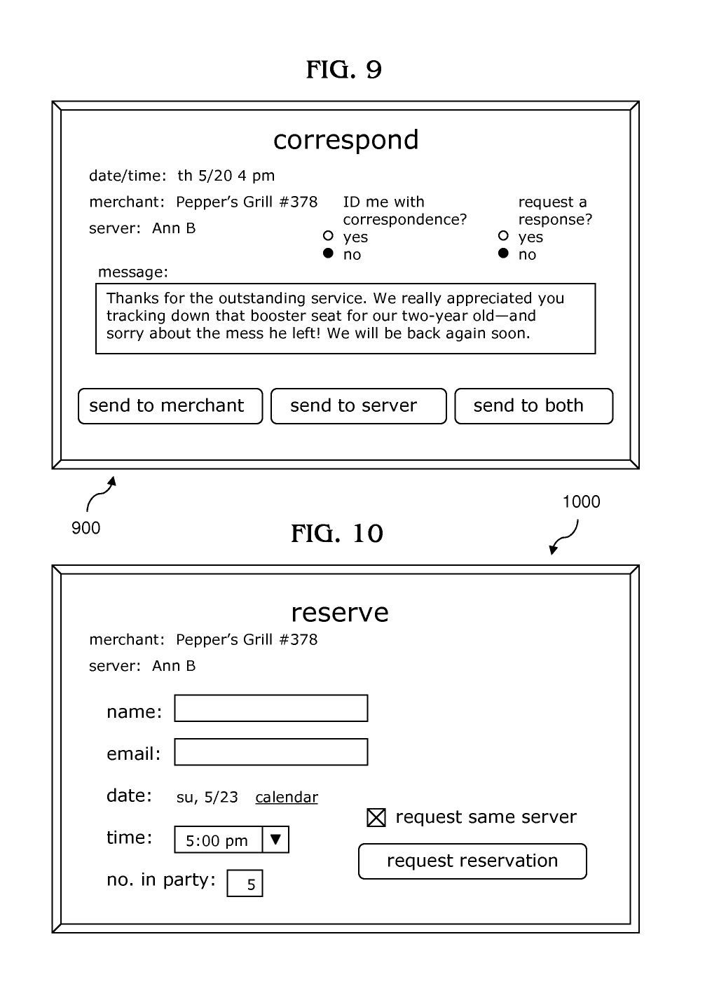

When customer 105 activates the “correspond” action button on home page 600, a correspondence page is generated for the selected transaction and displayed on smartphone 120 or computer 320. Referring to FIG. 9, correspondence page 900 identifies the date and time of the selected transaction, the service worker and merchant involved in the selected transaction, and contains widgets allowing customer 105 to correspond with the service worker or merchant.

Correspondence page 900 includes a text box allowing customer 105 to write a detailed message to be delivered to recipients.

Correspondence page 900 further includes radio buttons allowing customer 105 to indicate whether or not he or she wishes to maintain his or her anonymity. If customer 105 selects “yes,” a customer identifier associated with the user account of customer 105 is delivered with the correspondence. If customer 105 selects “no,” the correspondence is delivered without adding the customer identifier.

Correspondence page 900 further includes radio buttons allowing customer 105 to indicate whether he or she wishes to receive a response to the correspondence from recipients. If customer 105 selects “yes,” a response request is included with the correspondence along with an email address associated with the user account of customer 105. If customer 105 selects “no,” the correspondence is delivered without including a response request or customer email address.

Finally, correspondence page 900 includes action buttons allowing customer 105 to designate recipients of the correspondence by activating an appropriate button. If customer 105 actuates the “send to merchant” button, cloud server 312 formats the correspondence for delivery based on the transaction record and the customer inputs and the correspondence is delivered to the merchant but not to the service worker. In this regard, cloud server 312 may send a message containing the correspondence to an email or text message account of the merchant using an account address of the merchant obtained from merchant database 370. Alternatively, the correspondence may be downloaded by cloud server 312 to reaction storage facility 264 on smartphone 120 and automatically uploaded by transaction agent 262 to a merchant account on a message server at the merchant's premises in response to receiving the merchant identifier from a POS terminal in a subsequent NFC payment transaction with the merchant. In this alternative, the correspondence may be uploaded to the message server via a short-range communication protocol, such as NFC, Bluetooth or Wi-Fi.

If customer 105 actuates the “send to server” button, cloud server 312 formats the correspondence for delivery using the transaction record and the customer inputs and the correspondence is delivered to the service worker but not the merchant. In this regard, cloud server 312 may send the correspondence to an email or text message account of the service worker using an account address obtained from service worker database 380. Alternatively, the correspondence may be downloaded by cloud server 312 to reaction storage facility 264 on smartphone 120 and automatically uploaded by transaction agent 262 to a service worker account on a message server at the merchant's premises in response to receiving the merchant identifier and the service worker identifier from a POS terminal in a subsequent NFC payment transaction with the merchant. In this alternative, the correspondence may be uploaded to the message server via a short-range communication protocol, such as NFC, Bluetooth or Wi-Fi.

If customer 105 activates the “send to both” button, cloud server 312 formats the correspondence for delivery and the correspondence is delivered to both the merchant and the service worker by one or more of the above described delivery means.

### Reservation Request

When customer 105 activates the “reserve” action button on home page 600, a reservation page is generated for the selected transaction and displayed on smartphone 120 or computer 320. Referring to FIG. 10, reservation page 1000 identifies the service worker and merchant involved in the selected transaction and contains widgets allowing customer 105 to request a future transaction with the service worker or merchant.

Reservation page 1000 includes text boxes into which customer 105 inputs the name and email address of the party requesting the reservation. The name and email address are delivered to the merchant as part of the reservation request. In some embodiments, the name and email address are automatically retrieved by cloud server 312 from the user account of customer 105 and used to auto-fill these text boxes.

Reservation page 1000 further includes a calendar widget activated through a hyperlink allowing customer 105 to select the date of the requested reservation through a finger tap or mouse click on a calendar. The requested date is displayed on reservation page 1000 and is delivered to the merchant as part of the reservation request.

Reservation page 1000 further includes a drop-down list allowing customer 105 to select a time of the requested reservation. The requested time is delivered to the merchant as part of the reservation request.

Reservation page 1000 further includes a text box into which customer 105 inputs the number of people in the party requesting the reservation. This number is delivered to the merchant as part of the reservation request. A reservation page may include a drop-down list rather than a text box for inputting this information.

Reservation page 1000 further includes a checkbox that customer 105 fills if customer 105 wishes to have the same service worker (i.e., the service worker from the selected transaction) represent the merchant in the future transaction which is being requested. If the checkbox is filled, the reservation request delivered to the merchant contains a specific request that the service worker represent the merchant in the future transaction.

Finally, reservation page 1000 includes a “request reservation” action button. Activation of the “request reservation” action button causes cloud server 312 to format the reservation request for delivery using the transaction record and the customer inputs and deliver the reservation request to an email or text message account of the merchant using an address of the merchant retrieved from merchant database 370. The merchant then can respond to the reservation request using the customer's email information submitted with the request.

### Deffered Tipping

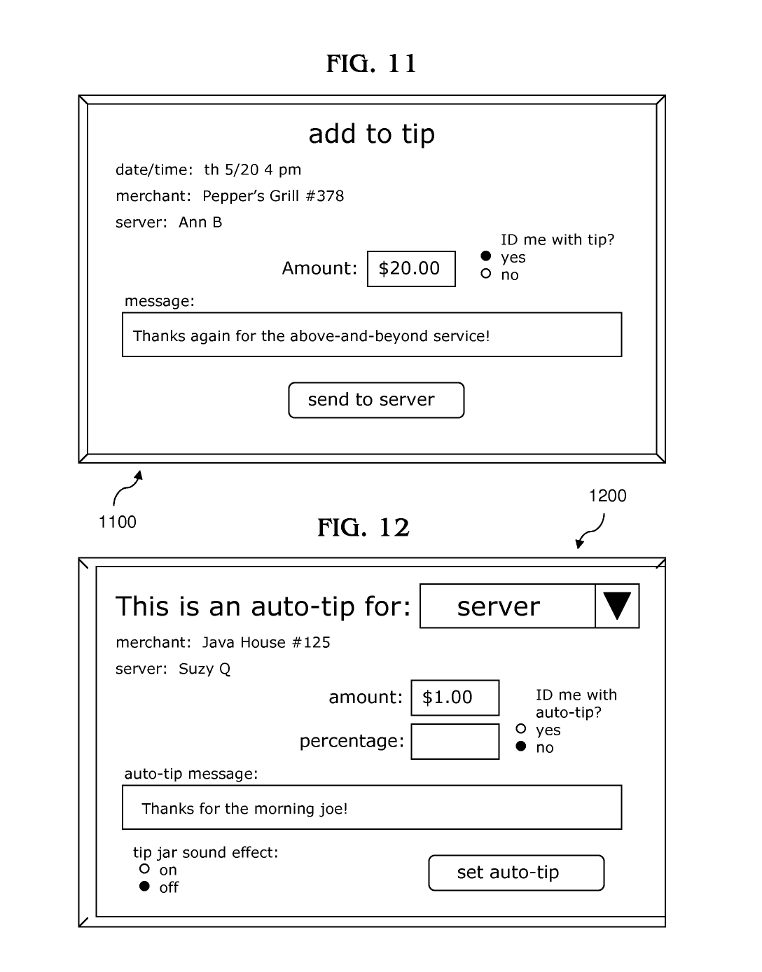

When customer 105 activates the “add to tip” action button on home page 600, a deferred tipping page is generated for the selected transaction and displayed on smartphone 120 or computer 320. Referring to FIG. 11, deferred tipping page 1100 identifies the date and time of the selected transaction, the service worker and merchant involved in the selected transaction, and contains widgets allowing customer 105 to give a belated gratuity to the service worker.

Deferred tipping page 1100 includes a text box into which customer 105 inputs the amount of the deferred tip.

Deferred tipping page 1100 further includes a text box allowing customer 105 to provide a message with the deferred tip. If customer 105 writes a message in the text box, the message is delivered with the deferred tip whenever possible.

Deferred tipping page 1100 further includes radio buttons allowing customer 105 to indicate whether he or she wishes to have his or her identity disclosed with the deferred tip. If customer 105 selects “yes,” a customer identifier associated with the user account of customer 105 is delivered with the deferred tip. If customer 105 checks “no,” the deferred tip is delivered without adding the customer identifier.

Finally, deferred tipping page 1100 includes a “send to server” button. When the “send to server” button is activated, cloud server 312 formats the deferred tip for delivery using the transaction record and the customer inputs and the deferred tip is delivered to the service worker involved in the selected transaction. In this regard, cloud server 312 may send the deferred tip to an online financial account of the service worker, such as a paypal account, hosted on an online financial platform 390 and send a tip notification email or text message to a messaging account owned by the service worker. Cloud server 312 may obtain the financial account address (e.g., paypal address) and messaging account address from service worker database 380 using the merchant identifier and the service worker identifier from the selected transaction as a lookup key.

### Preset Tipping

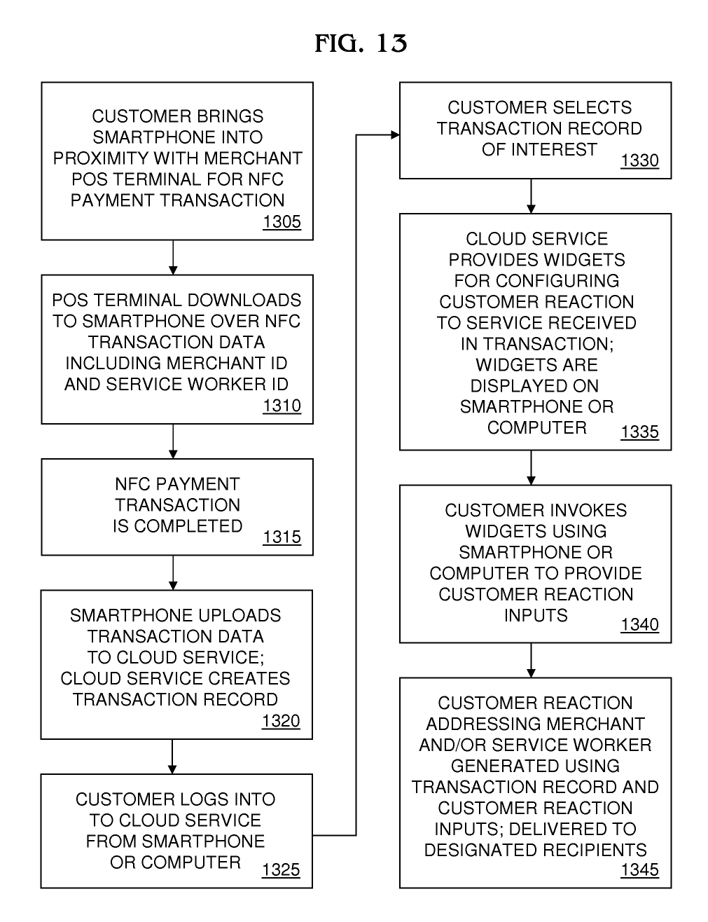

When customer 105 activates the “set auto-tip” action button on home page 600, a preset tipping page is generated for the selected transaction and displayed on smartphone 120 or computer 320. Referring to FIG. 12, a preset tipping page 1200 identifies the service worker and merchant involved in the selected transaction and contains widget allowing customer 105 to preset a gratuity to be automatically paid to the service worker or merchant in subsequent NFC payment transactions with the merchant.

Preset tipping page 1200 includes a drop-down list allowing customer 105 to designate the service worker or the merchant as the recipient of the preset tip. If the service worker is selected, the preset tip is automatically paid in future NFC payment transactions in which the merchant is represented by the service worker. If the merchant is selected, the preset tip is automatically paid in all future NFC payment transactions with the merchant, regardless of whether the service worker represents the merchant. In the event of a conflict, preset tips designating a service worker have precedence over those which do not designate a service worker.

Preset tipping page 1200 includes a text box into which customer 105 inputs a fixed amount of a preset tip. Preset tipping page 1200 also includes a percentage text box into which customer 105 inputs a fixed percentage of a preset tip. Customer 105 fills-in one of these text boxes depending on whether customer 105 wishes to establish a preset tip of a fixed amount or a fixed percentage.

Preset tipping page 1200 further includes a text box allowing customer 105 to provide a message with the preset tip. If customer 105 writes a message in the text box, the message is delivered along with the preset tip where possible. The message may, for example, be contained in an email message notifying the service worker that the tip has been added to his or her online financial account (e.g., paypal account) or displayed on a POS terminal when the tip is paid within an NFC payment transaction.

Preset tipping page 1200 further includes radio buttons allowing a customer to select whether smartphone 120 emits a tip jar sound effect reminiscent of coins dropping into a tip jar when the preset tip is paid within an NFC payment transaction flow. Such a sound effect can apprise both the customer and the service worker that the tip has been provided.

Preset tipping page 1200 further includes radio buttons allowing customer 105 to indicate whether he or she wishes to have his or her identity disclosed with the preset tip. If customer 105 selects “yes,” a customer identifier associated with the user account of customer 105 is delivered with the preset tip. If customer 105 checks “no,” the preset tip is delivered without adding the customer identifier.

Finally, preset tipping page 1200 includes a “set auto-tip” button. Activation of the “set auto-tip” button indicates that configuration of the preset tip is complete at which point cloud server 312 formats the preset tip for delivery based on the transaction record and the customer inputs.

In some embodiments, preset tips are delivered (i.e., paid) within the NFC payment transaction flow. In these embodiments, preset tips formulated as described above are downloaded by cloud server 312 to reaction storage facility 264 on smartphone 120 and are automatically added to payments for goods or services made via NFC under the control of transaction agent 262. For example, when customer 105 presets a $1.00 tip for transactions where merchant Java House #125 is represented by service worker Suzy Q, the preset tip is downloaded to smartphone 120 and stored on reaction storage facility 264. Then, whenever customer 105 is served by Suzy Q at Java House #125 and makes a purchase using smartphone 120, customer 105 provides an indication on user interface 240 to make an NFC payment causing the NFC payment application on secure element 250 and transaction agent 262 to execute. Customer 105 then brings smartphone 120 into proximity with a POS terminal and transaction agent 262 collects (either directly or via secure element 250) data related to the NFC payment transaction downloaded from the POS terminal over NFC interface 220 via the NFC protocol, including the merchant identifier (Java House #125) and the service worker identifier (Suzy Q). Transaction agent 262 searches reaction storage facility 264 using the merchant and service worker identifiers downloaded by the POS terminal as a lookup key and discovers that a preset tip of $1.00 is linked with that merchant and service worker. Transaction agent 262 then causes (either directly or via secure element 250) a message to be uploaded to the POS terminal over NFC interface 220 instructing to add a $1.00 tip to the transaction total and take any other terminal-side actions indicated in the preset tip (e.g., display an auto-tip message on the POS terminal). The NFC payment application then causes customer payment information stored in secure element 250 to be uploaded to the POS terminal over NFC interface 220. The POS terminal uses the customer payment information to pay for both the purchased good and the preset tip. Transaction agent 262 also causes smartphone 120 to take any smartphone-side actions indicated in the preset tip, such as emitting a tip jar sound effect when the tip is paid.

In other embodiments, preset tips are delivered (i.e., paid) via online financial platform 390. In these embodiments, preset tips are downloaded by cloud server 312 to reaction storage facility 264 on smartphone 120. When customer 105 provides an indication on user interface 240 to make an NFC payment, processor 210 invokes transaction agent 262. Customer 105 then brings smartphone 120 into proximity with a POS terminal and transaction agent 262 collects data related to the NFC payment transaction downloaded from the POS terminal over NFC interface 220 via the NFC protocol, including the merchant identifier and the service worker identifier. Transaction agent 262 then searches reaction storage facility 264 using the merchant and service worker identifiers and finds a preset tip linked with these identifiers. Transaction agent 262 then notifies cloud server 312, which sends the preset tip to an online financial account of the service worker, such as a paypal account, on online financial platform 390 and sends an email or text tip notification message to a messaging account of the service worker that conforms to terms of the preset tip (e.g., disclose or hide customer identity, provide auto-tip message, etc.). The financial and messaging account addresses of the service worker may be obtained from service worker database 380.

FIG. 13 shows a cloud-based method for facilitating a customer reaction to an NFC payment transaction conducted with a merchant represented by a service worker using an NFC-capable customer smartphone and an NFC-capable merchant POS terminal. The customer brings the smartphone into proximity with the POS terminal to pay for a good or service (1305). In some cases, the smartphone and the POS terminal are brought within four inches or less of one another. While the smartphone and the POS terminal are in proximity, the POS terminal downloads transaction data to the smartphone including a merchant identifier of the merchant and a service worker identifier of the service worker using the NFC protocol (1310). The NFC payment transaction is then completed (1315) and the smartphone uploads the transaction data to a cloud service, which creates a transaction record for the transaction including the merchant identifier and the service worker identifier and stores the transaction record in association with a user account of the customer managed by the cloud service (1320).

When the customer wishes to react to the service received in the transaction, the customer logs-in to the user account from the smartphone or another computer (1325). Once logged-in, the cloud service facilitates the customer in locating and selecting the record for the transaction of interest (1330). The cloud service then provides customer reaction widgets invocable by the customer to configure a customer reaction (1335). The customer invokes the widgets to provide customer reaction inputs (1340). The cloud service then generates a customer reaction in deliverable format using the transaction record and the customer reaction inputs and the reaction is delivered to designated recipients (1345).

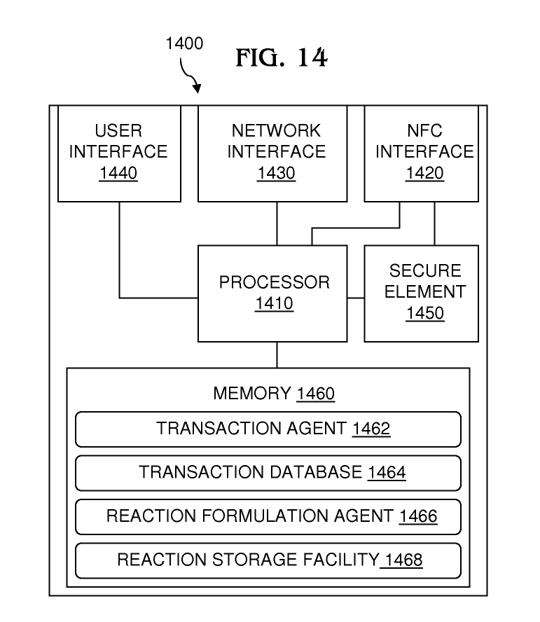

FIG. 14 shows a customer smartphone 1400 used in a client-based embodiment for facilitating customer reactions to NFC payment transactions conducted using smartphone 1400. As in the cloud-based embodiment, transaction data including an identifier of a merchant and an identifier of a service worker representing the merchant are downloaded from a POS terminal to smartphone 1400 via NFC data transfer in an NFC payment transaction. However, in the client-based embodiment, a cloud service is not invoked via a network interface 1430 to record the transaction or formulate a customer reaction to the transaction. Instead, smartphone 1400 locally creates and stores a record of the transaction using the transaction data and allows the customer to configure the customer reaction without interacting with a cloud service.

In the client-based embodiment, when the customer wishes to purchase a good using smartphone 1400, the customer provides an indication on user interface 1440 to make an NFC payment. In response, processor 1410 invokes an NFC payment application installed on a secure element 1450 and a transaction agent 1462 installed in memory 1460, both of which execute. The customer then brings smartphone 1400 into proximity with a POS terminal. While smartphone 1400 and the POS terminal are in proximity, transaction agent 1462 collects data related to the NFC payment transaction downloaded from the POS terminal over an NFC interface 1420 via the NFC protocol and the NFC payment application causes customer payment information to be uploaded from secure element 1450 to the POS terminal over NFC interface 1420 via the NFC protocol to make payment. The transaction data collected by transaction agent 1462 include an identifier of the merchant and the service worker representing the merchant in the transaction and may also include the date and time of the transaction and other information. If the date and time of the transaction are not included in the downloaded transaction data, transaction agent 1462 may add to the transaction data a timestamp with the date and time of the transaction. Transaction agent 1462 then creates a transaction record and stores the transaction record in a transaction database 1464.

After completing one or more NFC payment transactions in which transaction records are stored in transaction database 1464 in the foregoing manner, the customer may interact with smartphone 1400 to formulate a customer reaction to service received in one or more of the transactions by invoking through input on user interface 1440 a reaction formulation agent 1466 installed in memory 1460. When invoked, reaction formulation agent 1466 executes on processor 1410 and allows the customer to locate the transaction record for the transaction of interest through user input, select the transaction record through user input, and invoke customer reaction widgets through user input to configure the customer reaction. Reaction formulation agent 1466 then formats the customer reaction for delivery using the transaction record and the customer reaction inputs and causes the customer reaction to be delivered to designated recipients. Reaction formulation agent 1466 may store the customer reaction in a reaction storage facility 1468 where delivery is not immediate.

Considering a specific client-based example, after completing an NFC payment transaction where Java House #125 is represented by service worker Suzy Q, the customer may invoke reaction formulation agent 1466 via user interface 1440 causing agent 1466 to execute on processor 1410. Agent 1466 provides user interface elements allowing the customer to select the transaction record of interest and navigate to a preset tipping page. The customer may then invoke preset tipping widgets displayed on the preset tipping page (e.g., as shown in FIG. 12) to preset a $1.00 tip for future transactions where merchant Java House #125 is represented by service worker Suzy Q. Reaction formulation agent 1466 generates the preset tip using the transaction record and the customer reaction inputs and stores the preset tip in reaction storage facility 1468. Then, the next time the customer is served by Suzy Q at Java House #125 and wishes to make an NFC payment for goods or services using smartphone 1400, data related to the NFC payment transaction are downloaded from the POS terminal over NFC interface 1420 via the NFC protocol, including the merchant identifier (Java House #125) and the service worker identifier (Suzy Q). Transaction agent 1462 searches reaction storage facility 1468 using the merchant and service worker identifiers downloaded by the POS terminal as a lookup key and discovers that a preset tip of $1.00 is linked with that merchant and service worker. Transaction agent 1462 then causes (either directly or via secure element 1450) a message to be uploaded to the POS terminal over NFC interface 1420 instructing to add a $1.00 tip to the transaction total and take any other POS terminal-side actions indicated in the preset tip (e.g., display an auto-tip message on the POS terminal). The NFC payment application executing on secure element 1450 then causes customer payment information stored in secure element 1450 to be uploaded to the POS terminal over NFC interface 1420. The POS terminal uses the customer payment information to pay for both the purchased good or service and the preset tip. Transaction agent 1462 also causes smartphone 1400 to take any smartphone-side actions indicated in the preset tip, such as emitting a tip jar sound effect when the tip is paid.

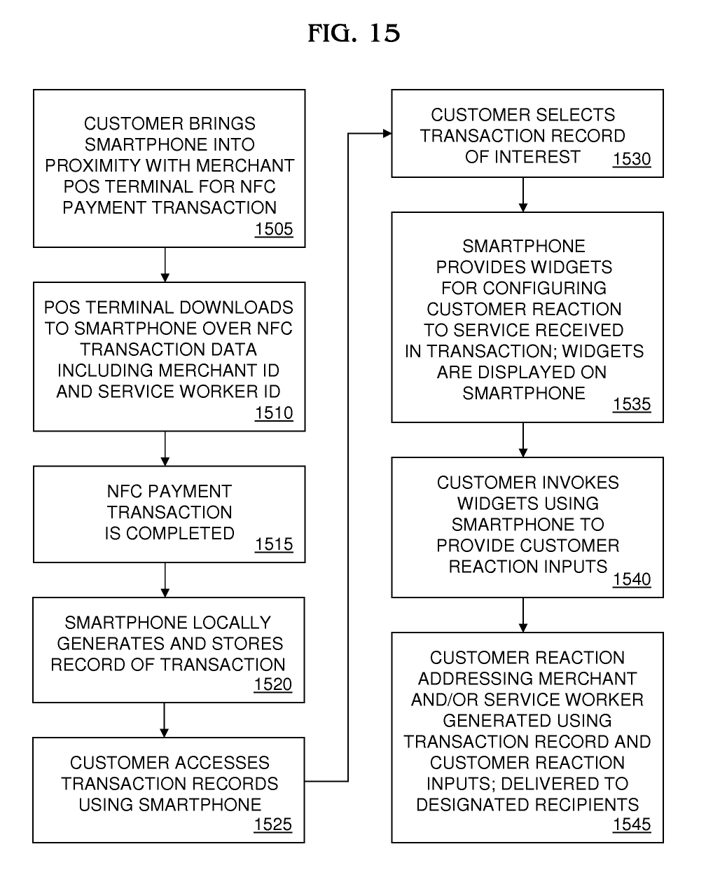

FIG. 15 shows a client-based method for facilitating a customer reaction to an NFC payment transaction conducted with a merchant represented by a service worker using an NFC-capable customer smartphone and an NFC-capable merchant POS terminal. The customer brings the smartphone into proximity with the POS terminal to pay for a good or service (1505). While the smartphone and the POS terminal are in proximity, the POS terminal downloads transaction data to the smartphone including a merchant identifier of the merchant and a service worker identifier of the service worker using the NFC protocol (1510). The NFC payment transaction is then completed (1515). The smartphone locally creates and stores a record of the transaction including the merchant identifier and the service worker identifier (1520).

When the customer wishes to react to the service received in the transaction, the customer accesses records for recent NFC payment transactions from the smartphone (1525). The smartphone facilitates the customer in locating the record for the transaction of interest and selecting that transaction (1530). The smartphone then provides customer reaction widgets which aid the customer in configuring a customer reaction (1535). The customer invokes the widgets to provide customer reaction inputs (1540). The smartphone then generates the customer reaction using the transaction record and the customer reaction inputs and the customer reaction is delivered to designated recipients (1545).

It will be appreciated by those of ordinary skill in the art that the invention can be embodied in other specific forms without departing from the spirit or essential character hereof. For example, while the invention has been described in some embodiments as involving NFC payment transactions, the invention is applicable to proximity mobile payment transactions conducted using other short-range data communication protocols, such as Bluetooth low energy (BLE), and short-range sound transfer protocols such as NearBytes. Moreover, while the invention has been described in some embodiments as involving download of both a merchant identifier and a service worker identifier from a POS terminal to a smartphone to facilitate a customer reaction, the invention is applicable to methods and systems wherein just one these identifiers is downloaded to facilitate a customer reaction. The present description is thus considered in all respects to be illustrative and not restrictive. The scope of the invention is indicated by the appended claims, and all changes that come with in the meaning and range of equivalents thereof are intended to be embraced therein.

What is claimed is:

1. A method for facilitating a customer reaction to a proximity mobile payment transaction, comprising:
receiving on a smartphone from a point of sale (POS) terminal, while the smartphone and the POS terminal are in proximity for a proximity mobile payment transaction, an identifier of a merchant and an identifier of a service worker representing the merchant;
storing a record of the transaction including the merchant identifier and the service worker identifier;
receiving a selection of the transaction record on a user interface;
receiving one or more customer reaction inputs made by invoking one or more customer reaction widgets on the user interface; and
delivering to one or more recipients a customer reaction addressing at least one of the merchant or the service worker generated using the transaction record and the customer reaction inputs.

2. The method of claim 1, wherein the customer reaction widgets comprise a rating widget.

3. The method of claim 1, wherein the customer reaction widgets comprise a recommendation widget.

4. The method of claim 1, wherein the customer reaction widgets comprise a correspondence widget.

5. The method of claim 1, wherein the customer reaction widgets comprise a reservation request widget.

6. The method of claim 1, wherein the customer reaction widgets comprise a deferred tipping widget.

7. The method of claim 1, wherein the customer reaction widgets comprise a preset tipping widget.

8. The method of claim 1, wherein the customer reaction widgets comprise a recipient designation widget.

9. The method of claim 1, wherein the customer reaction widgets comprise an identity protection widget.

10. The method of claim 1, wherein the customer reaction widgets comprise a response request widget.

11. The method of claim 1, wherein the user interface is on the smartphone.

12. The method of claim 1, wherein the user interface is on one of a desktop, notebook or tablet computer.

13. The method of claim 1, wherein the customer reaction is generated through interaction of the smartphone with a cloud service.

14. The method of claim 1, wherein the customer reaction is delivered to the recipients by a cloud service.

15. The method of claim 1, wherein the customer reaction is generated on the smartphone without interaction with a cloud service.

16. The method of claim 1, wherein the customer reaction is delivered to the recipients by the smartphone.

17. The method of claim 1, wherein the customer reaction is delivered to the recipients while the smartphone and the POS terminal are in proximity for a subsequent proximity mobile payment transaction.

18. The method of claim 1, wherein the customer reaction is a deferred tip delivered to an online payment account of the service worker.

19. The method of claim 1, wherein the customer reaction is a preset tip delivered to the service worker while the smartphone and the POS terminal are in proximity for a subsequent proximity mobile payment transaction.

20. The method of claim 1, wherein the proximity mobile payment transaction is a near field communication (NFC) payment transaction.

21. A smartphone, comprising:
a proximity mobile communication interface configured to receive from a point of sale (POS) terminal, while the smartphone and the POS terminal are in proximity for a proximity mobile payment transaction, an identifier of a merchant and an identifier of a service worker representing the merchant, and further configured to deliver to a POS terminal a customer reaction addressing at least one of the merchant or the service worker;
a memory configured to store a record of the transaction including the merchant identifier and the service worker identifier;
a user interface configured to receive a selection of the transaction record and further configured to receive one or more customer reaction inputs made by invoking one or more customer reaction widgets; and
a processor configured to generate the customer reaction using the transaction record and the customer reaction inputs.

22. The smartphone of claim 21, wherein the customer reaction is a tip for the service worker.

23. The smartphone of claim 21, wherein the customer reaction is a preset tip for the service worker delivered while the smartphone and the POS terminal are in proximity for a subsequent proximity mobile payment transaction.

24. The smartphone of claim 21, wherein the proximity mobile communication interface is a near field communication (NFC) interface.

25. A method for facilitating a customer reaction to a proximity mobile payment transaction, comprising:
receiving on a smartphone from a point of sale (POS) terminal, while the smartphone and the POS terminal are in proximity for a proximity mobile payment transaction, an identifier of a service worker representing a merchant;
storing a record of the transaction including the service worker identifier;
receiving a selection of the transaction record on a user interface;
accessing a web address of a profile of the service worker using the service worker identifier;
receiving a request to review the profile made by invoking a service worker profile widget on the user interface;
accessing the profile using the web address; and
displaying the profile on the user interface.

26. The method of claim 25, wherein the profile is hosted on a third party social networking platform.

27. The method of claim 25, wherein the proximity mobile payment transaction is a near field communication (NFC) payment transaction.

28. A method for facilitating a customer reaction to a proximity mobile payment transaction, comprising:
receiving on a smartphone from a point of sale (POS) terminal, while the smartphone and the POS terminal are in proximity for a proximity mobile payment transaction, an identifier of a service worker representing a merchant;
storing a record of the transaction including the service worker identifier;
receiving a selection of the transaction record on a user interface;
receiving one or more customer reaction inputs made by invoking one or more customer reaction widgets on the user interface; and
delivering to one or more recipients a customer reaction addressing the service worker generated using the transaction record and the customer reaction inputs.

29. A method for facilitating a customer reaction to a proximity mobile payment transaction, comprising:
receiving on a smartphone from a point of sale (POS) terminal, while the smartphone and the POS terminal are in proximity for a proximity mobile payment transaction, an identifier of a merchant;
storing a record of the transaction including the merchant identifier;
receiving a selection of the transaction record on a user interface;
receiving one or more customer reaction inputs made by invoking one or more customer reaction widgets on the user interface; and
delivering to one or more recipients a customer reaction addressing the merchant generated using the transaction record and the customer reaction inputs.
